(19) United States
(12) Patent Application Publication
(10) Pub. No.: US 2026/0231087 A1
(43) Pub. Date: Aug. 6, 2026

(54) Systems and Methods of Inter-Device Coordination for Sidelink Positioning

(71) Applicant: Apple Inc., Cupertino, CA (US)

(72) Inventors: Chunxuan Ye, San Diego, CA (US); Oghenekome Oteri, San Diego, CA (US); Sigen Ye, San Diego, CA (US); Dawei Zhang, Saratoga, CA (US); Wei Zeng, Saratoga, CA (US); Haitong Sun, Saratoga, CA (US); Hong He, San Jose, CA (US); Weidong Yang, San Diego, CA (US); Jie Cui, San Jose, CA (US); Chunhai Yao, Beijing (CN)

(21) Appl. No.: 19/149,493

(22) PCT Filed: Jan. 29, 2023
(86) PCT No.: PCT/CN2023/073709

§ 371 Date: Jul. 18, 2025

(51) Int. Cl. H04W 64/00; H04L 5/00; H04W 92/18

(52) U.S. Cl. CPC H04W 64/00; H04L 5/0048; H04W 92/18

(57) ABSTRACT

Mobile devices (UEs) may use Inter-UE Control (IUC) sidelink (SL) communications for SL positioning reference signal (SL-PRS) resource allocation procedures without relying on a network/base station/cell. A transmitting UE may receive, e.g., from an assisting UE, an indication identifying preferred SL-PRS resources for the transmitting UE to consider and/or non-preferred SL-PRS resources for the transmitting UE to avoid. The indication may be received in response to an IUC triggering condition or in response to a request previously transmitted by the transmitting UE to the assisting UE. Alternatively, the transmitting UE may first attempt to reserve specified SL-PRS resources by transmitting, to an assisting UE, a reservation request identifying the specified SL-PRS resources. The transmitting UE may receive, in response, information about SL-PRS resource reservation collisions involving the specified SL-PRS resources. The transmitting UE may (re)select SL-PRS resources based on the received indication(s), and transmit the SL-PRS using the (re)selected resources.

### FIELD OF THE INVENTION

The present application relates to wireless communications, including sidelink positioning during/in wireless communications, e.g., during/in 5G NR communications.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (WCDMA, TDS-CDMA), LTE, LTE Advanced (LTE-A), HSPA, 3GPP 2 CDMA 2000 (e.g., 1xRTT, 1xEV-DO, HRPD, eHRPD), IEEE 802.11 (WLAN or Wi-Fi), IEEE 802.16 (WiMAX), BLUETOOTH™, etc. A current telecommunications standard moving beyond previous standards is called 5th generation mobile networks or 5th generation wireless systems, referred to as 3GPP NR (otherwise known as 5G-NR or NR-5G for 5G New Radio, also simply referred to as NR). NR proposes a higher capacity for a higher density of mobile broadband users, also supporting device-to-device, ultra-reliable, and massive machine communications, as well as lower latency and lower battery consumption, than LTE standards.

One aspect of wireless communication systems, including NR cellular wireless communications, involves device-to-device communications, including sidelink communications, and device positioning during sidelink communications. Improvements in the field are desired.

### SUMMARY OF THE INVENTION

Embodiments are presented herein of, inter alia, of methods and procedures for inter-device coordination for sidelink positioning, during wireless communications, for example during 3GPP New Radio (NR) communications. Embodiments are further presented herein for wireless communication systems containing at least wireless communication devices or user equipment devices (UEs) and/or base stations communicating with each other within the wireless communication systems.

As disclosed herein, various wireless communication devices (e.g., user equipment devices, UEs) may support autonomous sidelink positioning reference signal (SL-PRS) resource allocation. The UEs may thereby perform SL-PRS resource allocation procedures without relying on a network or base station or cell for the SL-PRS specification and SL-PRS resource allocation. At least two different approaches may be considered.

According to a first approach, a transmitting UE may receive, e.g., from an assisting UE, an indication identifying preferred SL-PRS resources for the transmitting UE to consider and/or non-preferred SL-PRS resources for the transmitting UE to avoid. The indication may be received in response to an IUC triggering condition or in response to a resource request previously transmitted by the transmitting UE to the assisting UE for SL-PRS resources. The transmitting UE may select SL-PRS resources based on the received indication(s), and may transmit the SL-PRS using the selected resources.

According to a second approach, the transmitting UE may first attempt to reserve specified SL-PRS resources (e.g., SL-PRS resources identified by the transmitting UE), by transmitting, to an assisting UE, a reservation request identifying the specified SL-PRS resources. The assisting UE may in turn determine if the specified SL-PRS resources are involved in any SL-PRS resource reservation collisions, and may accordingly transmit to the transmitting UE an indication/information about such SL-PRS resource reservation collisions. The transmitting UE may (re)select SL-PRS resources based on the received indication, and may transmit the SL-PRS using the (re)selected resources.

Note that the techniques described herein may be implemented in and/or used with a number of different types of devices, including but not limited to, base stations, access points, cellular phones, portable media players, tablet computers, wearable devices, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments;

FIG. 5 shows an exemplary simplified block diagram illustrative of cellular communication circuitry, according to some embodiments;

FIG. 6 shows an exemplary flow diagram of a request-based Inter-UE Coordination (IUC) SL positioning procedure from the perspective of a transmitting UE, according to some embodiments;

FIG. 7 shows an exemplary flow diagram of a request-based IUC SL positioning procedure from the perspective of an assisting UE, according to some embodiments;

FIG. 8 shows an exemplary diagram illustrating a resource pool slot structure that supports resource pool (pre)configuration for SL positioning, according to some embodiments;

FIG. 9 shows an exemplary flow diagram of a condition-based IUC SL positioning procedure from the perspective of a transmitting UE, according to some embodiments;

FIG. 10 shows flow diagram of a an IUC SL positioning procedure that includes an SL-PRS resource reservation request, from the perspective of an assisting UE, according to some embodiments;

FIG. 11 shows an exemplary flow diagram of a reservation-based IUC SL positioning procedure from the perspective of a transmitting UE, according to some embodiments;

FIG. 12 shows an exemplary flow diagram of a reservation-based IUC SL positioning procedure from the perspective of an assisting UE, according to some embodiments; and

FIG. 13 shows an exemplary diagram illustrating the organization of resources used for IUC for SL-PRS communications, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION OF THE EMBODIMENTS

### Acronyms

Various acronyms are used throughout the present application. Definitions of the most prominently used acronyms that may appear throughout the present application are provided below:
5GMM: 5G Mobility Management
AF: Application Function
AMF: Access and Mobility Management Function
AMR: Adaptive Multi-Rate
AP: Access Point
APN: Access Point Name
APR: Applications Processor
BS: Base Station
BSR: Buffer Status Report
BSSID: Basic Service Set Identifier
CA: Carrier Aggregation
CBG: Code Block Group
CBRS: Citizens Broadband Radio Service
CBSD: Citizens Broadband Radio Service Device
CBW: Channel Bandwidth
CCA: Clear Channel Assessment
CMR: Change Mode Request
CORESET: Control Resource Set
CS: Circuit Switched
CSI: Channel State Information
DC: Dual Connectivity
DCI: Downlink Control Information
DL: Downlink (from BS to UE)
DMRS: Demodulation Reference Signal
DN: Data Network
DSDS: Dual SIM Dual Standby
DYN: Dynamic
EDCF: Enhanced Distributed Coordination Function
eSNPN: Equivalent Standalone Non-Public Network
ETSI: European Telecommunications Standards Institute
FDD: Frequency Division Duplexing
FT: Frame Type
GAA: General Authorized Access
GPRS: General Packet Radio Service
GSM: Global System for Mobile Communication
GTP: GPRS Tunneling Protocol
HPLMN: Home Public Land Mobile Network
IC: In Coverage
ICBM: Inter-Cell Beam Management
IMS: Internet Protocol Multimedia Subsystem
IOT: Internet of Things
IP: Internet Protocol
ITS: Intelligent Transportation Systems
IUC: Inter-UE Coordination
LAN: Local Area Network
LBT: Listen Before Talk
LCID: Logical Channel ID
LCS: Location Services
LMF: Location Management Function
LPP: LTE Positioning Protocol
LQM: Link Quality Metric
LTE: Long Term Evolution
MCC: Mobile Country Code
MCS: Modulation and Coding Scheme
MNO: Mobile Network Operator
MO-LR: Mobile Originated Location Request
MT-LR: Mobile-Terminated Location Request
NAS: Non-Access Stratum
NDI: New Data Indicator
NF: Network Function
NG: Next Generation
NG-RAN: Next Generation Radio Access Network
NID: Network Identifier
NMF: Network Identifier Management Function
NPN: Non-Public (cellular) Network
NRF: Network Repository Function
NSI: Network Slice Instance
NSSAI: Network Slice Selection Assistance Information
OLPC: Open Loop Power Control
OOC: Out Of Coverage
PAL: Priority Access Licensee
PBCH: Physical Broadcast Channel
PDCP: Packet Data Convergence Protocol
PDN: Packet Data Network
PDU: Protocol Data Unit
PGW: PDN Gateway
PLMN: Public Land Mobile Network
ProSe: Proximity Services
PRS: Positioning Reference Signal
PSCCH: Physical Sidelink Control Channel
PSFCH: Physical Sidelink Feedback Channel
PSSCH: Physical Sidelink Shared Channel
PSD: Power Spectral Density
PSS: Primary Synchronization Signal
PT: Payload Type
PTRS: Phase Tracking Reference Signal
PUCCH: Physical Uplink Control Channel
QBSS: Quality of Service Enhanced Basic Service Set
QI: Quality Indicator
RA: Registration Accept
RAN: Radio Access Network
RAT: Radio Access Technology
RE: Resource Element
RF: Radio Frequency
RLM: Radio Link Monitoring
RNTI: Radio Network Temporary Identifier
ROHC: Robust Header Compression
RR: Registration Request
RRC: Radio Resource Control
RRM: Radio Resource Management
RS: Reference Signal
RSRP: Reference Signal Receive Power
RTP: Real-time Transport Protocol
RTT: Round Trip Time
RV: Redundancy Version
RX: Reception/Receive
SAS: Spectrum Allocation Server
SCI: Sidelink Control Information
SCS: Subcarrier Spacing
SD: Slice Descriptor
SI: System Information
SIB: System Information Block
SID: System Identification Number
SLPP: Sidelink Positioning Procedures
SIM: Subscriber Identity Module
SINR: Signal-To-Interference-Plus-Noise Ratio
SGW: Serving Gateway
SMF: Session Management Function
SNPN: Standalone Non-Public Network
SRS: Sounding Reference Signal
SSB: Synchronization Signal Block
SSS: Secondary Synchronization Signal
SUPI: Subscription Permanent Identifier
TBS: Transport Block Size
TCP: Transmission Control Protocol
TDD: Time Division Duplexing
TDOA: Time Difference of Arrival
TDRA: Time Domain Resource Allocation
TPC: Transmit Power Control
TRP: Transmission/Reception Point
TX: Transmission/Transmit
UAC: Unified Access Control
UDM: Unified Data Management
UDR: User Data Repository
UE: User Equipment
UI: User Input
UL: Uplink (from UE to BS)
UMTS: Universal Mobile Telecommunication System
UPF: User Plane Function
URLLC: Ultra-Reliable Low-Latency Communication
URM: Universal Resources Management
URSP: UE Route Selection Policy
USIM: User Subscriber Identity Module
Wi-Fi: Wireless Local Area Network (WLAN) RAT based on the Institute of Electrical and Electronics Engineers' (IEEE) 802.11 standards
WLAN: Wireless LAN
ZP: Zero Power

### Terms

The following is a glossary of terms that may appear in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—Includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems devices which perform wireless communications. Also referred to as wireless communication devices, many of which may be mobile and/or portable. Examples of UE devices include mobile telephones or smart phones (e.g., iPhone™, Android™-based phones) and tablet computers such as iPad™, Samsung Galaxy™, etc., gaming devices (e.g. Sony PlayStation™, Microsoft XBox™, etc.), portable gaming devices (e.g., Nintendo DS™, PlayStation Portable™, Gameboy Advance™, iPod™), laptops, wearable devices (e.g. smart watch, smart glasses), PDAs, portable Internet devices, music players, data storage devices, or other handheld devices, unmanned aerial vehicles (e.g., drones) and unmanned aerial controllers, etc. Various other types of devices would fall into this category if they include Wi-Fi or both cellular and Wi-Fi communication capabilities and/or other wireless communication capabilities, for example over short-range radio access technologies (SRATs) such as BLUETOOTH™, etc. In general, the term “UE” or “UE device” may be broadly defined to encompass any electronic, computing, and/or telecommunications device (or combination of devices) which is capable of wireless communication and may also be portable/mobile.

Wireless Device (or wireless communication device)—any of various types of computer systems devices which performs wireless communications using WLAN communications, SRAT communications, Wi-Fi communications and the like. As used herein, the term “wireless device” may refer to a UE device, as defined above, or to a stationary device, such as a stationary wireless client or a wireless base station. For example a wireless device may be any type of wireless station of an 802.11 system, such as an access point (AP) or a client station (UE), or any type of wireless station of a cellular communication system communicating according to a cellular radio access technology (e.g. 5G NR, LTE, CDMA, GSM), such as a base station or a cellular telephone, for example.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processor—refers to various elements (e.g. circuits) or combinations of elements that are capable of performing a function in a device, e.g. in a user equipment device or in a cellular network device. Processors may include, for example: general purpose processors and associated memory, portions or circuits of individual processor cores, entire processor cores or processing circuit cores, processing circuit arrays or processor arrays, circuits such as ASICs (Application Specific Integrated Circuits), programmable hardware elements such as a field programmable gate array (FPGA), as well as any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band (or Frequency Band)—The term “band” has the full breadth of its ordinary meaning, and at least includes a section of spectrum (e.g., radio frequency spectrum) in which channels are used or set aside for the same purpose. Furthermore, “frequency band” is used to denote any interval in the frequency domain, delimited by a lower frequency and an upper frequency. The term may refer to a radio band or an interval of some other spectrum. A radio communications signal may occupy a range of frequencies over which (or where) the signal is carried. Such a frequency range is also referred to as the bandwidth of the signal. Thus, bandwidth refers to the difference between the upper frequency and lower frequency in a continuous band of frequencies. A frequency band may represent one communication channel or it may be subdivided into multiple communication channels. Allocation of radio frequency ranges to different uses is a major function of radio spectrum allocation. For example, in 5G NR, the operating frequency bands are categorized in two groups. More specifically, per 3GPP Release 15, frequency bands are designated for different frequency ranges (FR) and are defined as FR1 and FR2, with FR1 encompassing the 410 MHz-7125 MHz range and FR2 encompassing the 24250 MHz-52600 MHz range.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Station (STA)—The term “station” herein refers to any device that has the capability of communicating wirelessly, e.g. by using the 802.11 protocol. A station may be a laptop, a desktop PC, PDA, access point or Wi-Fi phone or any type of device similar to a UE. An STA may be fixed, mobile, portable or wearable. Generally in wireless networking terminology, a station (STA) broadly encompasses any device with wireless communication capabilities, and the terms station (STA), wireless client (UE) and node (BS) are therefore often used interchangeably.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Transmission Scheduling—Refers to the scheduling of transmissions, such as wireless transmissions. In some implementations of cellular radio communications, signal and data transmissions may be organized according to designated time units of specific duration during which transmissions take place. As used herein, the term “slot” has the full extent of its ordinary meaning, and at least refers to a smallest (or minimum) scheduling time unit in wireless communications. For example, in 3GPP LTE, transmissions are divided into radio frames, each radio frame being of equal (time) duration (e.g. 10 ms). A radio frame in 3GPP LTE may be further divided into a specified number of (e.g. ten) subframes, each subframe being of equal time duration, with the subframes designated as the smallest (minimum) scheduling unit, or the designated time unit for a transmission. Thus, in a 3GPP LTE example, a “subframe” may be considered an example of a “slot” as defined above. Similarly, a smallest (or minimum) scheduling time unit for 5G NR (or NR, for short) transmissions is referred to as a “slot”. In different communication protocols the smallest (or minimum) scheduling time unit may also be named differently.

Resources—The term “resource” has the full extent of its ordinary meaning and may refer to frequency resources and time resources used during wireless communications. As used herein, a resource element (RE) refers to a specific amount or quantity of a resource. For example, in the context of a time resource, a resource element may be a time period of specific length. In the context of a frequency resource, a resource element may be a specific frequency bandwidth, or a specific amount of frequency bandwidth, which may be centered on a specific frequency. As one specific example, a resource element may refer to a resource unit of 1 symbol (in reference to a time resource, e.g. a time period of specific length) per 1 subcarrier (in reference to a frequency resource, e.g. a specific frequency bandwidth, which may be centered on a specific frequency). A resource element group (REG) has the full extent of its ordinary meaning and at least refers to a specified number of consecutive resource elements. In some implementations, a resource element group may not include resource elements reserved for reference signals. A control channel element (CCE) refers to a group of a specified number of consecutive REGs. A resource block (RB) refers to a specified number of resource elements made up of a specified number of subcarriers per specified number of symbols. Each RB may include a specified number of subcarriers. A resource block group (RBG) refers to a unit including multiple RBs. The number of RBs within one RBG may differ depending on the system bandwidth.

Bandwidth Part (BWP)—A carrier bandwidth part (BWP) is a contiguous set of physical resource blocks selected from a contiguous subset of the common resource blocks for a given numerology on a given carrier. For downlink, a UE may be configured with up to a specified number of carrier BWPs (e.g. four BWPs, per some specifications), with one BWP per carrier active at a given time (per some specifications). For uplink, the UE may similarly be configured with up to several (e.g. four) carrier BWPs, with one BWP per carrier active at a given time (per some specifications). If a UE is configured with a supplementary uplink, then the UE may be additionally configured with up to the specified number (e.g. four) carrier BWPs in the supplementary uplink, with one carrier BWP active at a given time (per some specifications).

Multi-cell Arrangements—A Master node is defined as a node (radio access node) that provides control plane connection to the core network in case of multi radio dual connectivity (MR-DC). A master node may be a master eNB (3GPP LTE) or a master gNB (3GPP NR), for example. A secondary node is defined as a radio access node with no control plane connection to the core network, providing additional resources to the UE in case of MR-DC. A Master Cell group (MCG) is defined as a group of serving cells associated with the Master Node, including the primary cell (PCell) and optionally one or more secondary cells (SCell). A Secondary Cell group (SCG) is defined as a group of serving cells associated with the Secondary Node, including a special cell, namely a primary cell of the SCG (PSCell), and optionally including one or more SCells. A UE may typically apply radio link monitoring to the PCell. If the UE is configured with an SCG then the UE may also apply radio link monitoring to the PSCell. Radio link monitoring is generally applied to the active BWPs and the UE is not required to monitor inactive BWPs. The PCell is used to initiate initial access, and the UE may communicate with the PCell and the SCell via Carrier Aggregation (CA). Currently Amended capability means a UE may receive and/or transmit to and/or from multiple cells. The UE initially connects to the PCell, and one or more SCells may be configured for the UE once the UE is in a connected state.

Core Network (CN)—Core network is defined as a part of a 3GPP system which is independent of the connection technology (e.g. the Radio Access Technology, RAT) of the UEs. The UEs may connect to the core network via a radio access network, RAN, which may be RAT-specific.

Downlink Control Information (DCI)—in 3gpp Communications, DCI Is Transmitted to a mobile device or UE (e.g., by a serving base station in the network) and contains multiple different fields. Each field is used to configure one part or aspect of a scheduled communication(s) of the device. To put it another way, each field in the DCI may correspond to a specific communication parameter or parameters configuring a corresponding aspect of the scheduled communication(s) of the device. By decoding the DCI, the UE obtains all the configuring parameters or parameter values according to the fields in the DCI, thereby obtaining all the information about the scheduled communication(s) and subsequently performing the scheduled communication(s) according to those parameters/parameter values.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

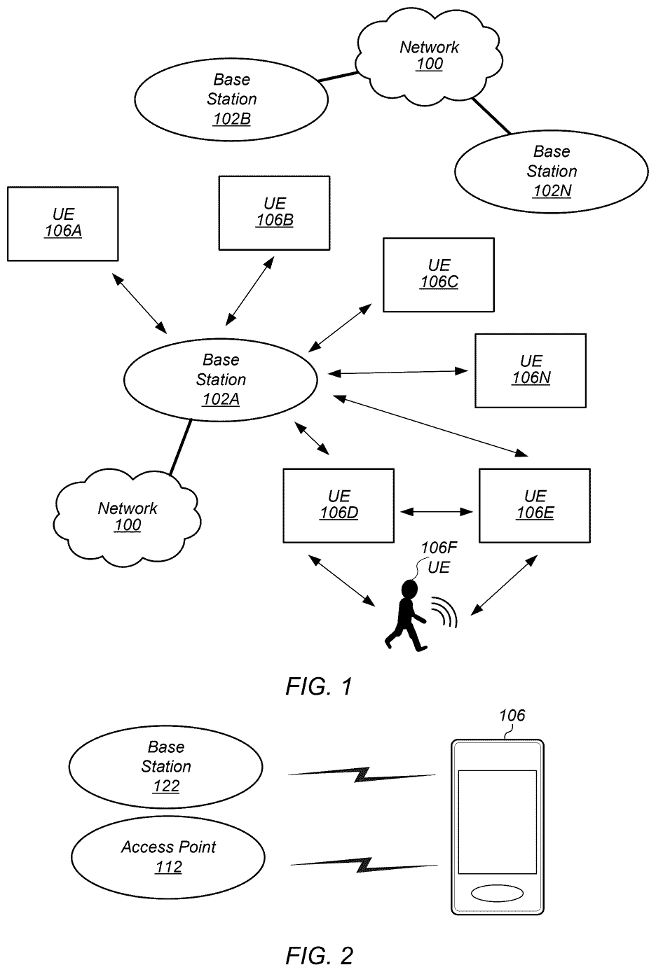

### FIGS. 1 and 2—Exemplary Communication Systems

FIG. 1 illustrates an exemplary (and simplified) wireless communication system, according to some embodiments. It is noted that the system of FIG. 1 is merely one example of a possible system, and embodiments may be implemented in any of various systems, as desired.

As shown, the exemplary wireless communication system includes base stations 102A through 102N, also collectively referred to as base station(s) 102 or base station 102. As shown in FIG. 1, base station 102A communicates over a transmission medium with one or more user devices 106A through 106N. Each of the user devices may be referred to herein as a “user equipment” (UE) or UE device. Thus, the user devices 106A through 106N are referred to as UEs or UE devices, and are also collectively referred to as UE(s) 106 or UE 106.

The base station 102A may be a base transceiver station (BTS) or cell site, and may include hardware that enables wireless communication with the UEs 106A through 106N. The base station 102A may also be equipped to communicate with a network 100 (e.g., a core network of a cellular service provider, a telecommunication network such as a public switched telephone network (PSTN), and/or the Internet, neutral host or various CBRS (Citizens Broadband Radio Service) deployments, among various possibilities). Thus, the base station 102A may facilitate communication between the user devices 106 and/or between the user devices 106 and the network 100. In particular, the cellular base station 102A may provide UEs 106 with various telecommunication capabilities, such as voice, short message service (SMS) and/or data services. The communication area (or coverage area) of the base station 106 may be referred to as a “cell.” It is noted that “cell” may also refer to a logical identity for a given wireless communication coverage area at a given frequency. In general, any independent cellular wireless coverage area may be referred to as a “cell”. In such cases a base station may be situated at particular confluences of three cells. The base station, in this uniform topology, may serve three 120 degree beam width areas referenced as cells. Also, in case of carrier aggregation, small cells, relays, etc. may each represent a cell. Thus, in carrier aggregation in particular, there may be primary cells and secondary cells which may service at least partially overlapping coverage areas but on different respective frequencies. For example, a base station may serve any number of cells, and cells served by a base station may or may not be collocated (e.g. remote radio heads). As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network, and may further also be considered at least a part of the UE communicating on the network or over the network.

The base station(s) 102 and the user devices 106 may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G-NR (NR, for short), 3GPP 2 CDMA 2000 (e.g., 1xRTT, 1xEV-DO, HRPD, eHRPD), Wi-Fi, WiMAX etc. Note that if the base station 102A is implemented in the context of LTE, it may alternately be referred to as an ‘eNodeB’ or ‘eNB’. Similarly, if the base station 102A is implemented in the context of 5G NR, it may alternately be referred to as ‘gNodeB’ or ‘gNB’. In some embodiments, the base station 102 (e.g. an eNB in an LTE network or a gNB in an NR network) may communicate with at least one UE having the capability to transmit reference signals according to various embodiments disclosed herein. Depending on a given application or specific considerations, for convenience some of the various different RATs may be functionally grouped according to an overall defining characteristic. For example, all cellular RATs may be collectively considered as representative of a first (form/type of) RAT, while Wi-Fi communications may be considered as representative of a second RAT. In other cases, individual cellular RATs may be considered individually as different RATs. For example, when differentiating between cellular communications and Wi-Fi communications, “first RAT” may collectively refer to all cellular RATs under consideration, while “second RAT” may refer to Wi-Fi. Similarly, when applicable, different forms of Wi-Fi communications (e.g. over 2.4 GHz vs. over 5 GHz) may be considered as corresponding to different RATs. Furthermore, cellular communications performed according to a given RAT (e.g. LTE or NR) may be differentiated from each other on the basis of the frequency spectrum in which those communications are conducted. For example, LTE or NR communications may be performed over a primary licensed spectrum as well as over a secondary spectrum such as an unlicensed spectrum and/or spectrum that was assigned to private networks. Overall, the use of various terms and expressions will always be clearly indicated with respect to and within the context of the various applications/embodiments under consideration.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices 106 and/or between the user devices 106 and the network 100. In particular, the cellular base station 102A may provide UEs 106 with various telecommunication capabilities, such as voice, SMS and/or data services. UE 106 may be capable of communicating using multiple wireless communication standards. For example, a UE 106 might be configured to communicate using any or all of a 3GPP cellular communication standard (such as LTE or NR) or a 3GPP 2 cellular communication standard (such as a cellular communication standard in the CDMA2000 family of cellular communication standards). Base station 102A and other similar base stations (such as base stations 102B . . . 102N) operating according to the same or a different cellular communication standard may thus be provided as one or more networks of cells, which may provide continuous or nearly continuous overlapping service to UE 106 and similar devices over a wide geographic area via one or more cellular communication standards.

Thus, while base station 102A may act as a “serving cell” for UEs 106A-106N as illustrated in FIG. 1, each one of UE(s) 106 may also be capable of receiving signals from (and may possibly be within communication range of) one or more other cells (possibly provided by base stations 102B-102N and/or any other base stations), which may be referred to as “neighboring cells”. Such cells may also be capable of facilitating communication in-between user devices 106 and/or between user devices 106 and the network 100. Such cells may include “macro” cells, “micro” cells, “pico” cells, and/or cells which provide any of various other granularities of service area size. For example, base stations 102A-102B illustrated in FIG. 1 may be macro cells, while base station 102N may be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transmission and reception points (TRPs). In addition, a UE capable of operating according to 5G NR may be connected to one or more TRPs within one or more gNBs.

The UE 106 might also or alternatively be configured to communicate using WLAN, BLUETOOTH™, BLUETOOTH™ Low-Energy, one or more global navigational satellite systems (GNSS, e.g., GPS or GLONASS), one and/or more mobile television broadcasting standards (e.g., ATSC-M/H or DVB-H), etc. Other combinations of wireless communication standards (including more than two wireless communication standards) are also possible. Furthermore, the UE 106 may also communicate with Network 100, through one or more base stations or through other devices, stations, or any appliances not explicitly shown but considered to be part of Network 100. UE 106 communicating with a network may therefore be interpreted as the UE(s) 106 communicating with one or more network nodes considered to be a part of the network and which may interact with the UE(s) 106 to conduct communications with the UE(s) 106 and in some cases affect at least some of the communication parameters and/or use of communication resources of the UE(s) 106.

As also illustrated in FIG. 1, at least some of the UEs, e.g. UEs 106D and 106E may represent vehicles communicating with each other and with base station 102, e.g. via cellular communications such as 3GPP LTE and/or 5G-NR communications, for example. In addition, UE 106F may represent a pedestrian who is communicating and/or interacting in a similar manner with the vehicles represented by UEs 106D and 106E. Various embodiments of vehicles communicating in a network exemplified in FIG. 1 are disclosed, for example, in the context of vehicle-to-everything (V2X) communications such as the communications specified by certain versions of the 3GPP standard, among others.

FIG. 2 illustrates an exemplary user equipment 106 (e.g., one of UEs 106A through 106N) in communication with the base station 122 and an access point 112, according to some embodiments. The UE 106 may be a device with both cellular communication capability and non-cellular communication capability (e.g., BLUETOOTH™, Wi-Fi, and so forth) such as a mobile phone, a hand-held device, a computer or a tablet, or virtually any type of wireless device. The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, NR, WLAN, or GNSS. Other combinations of wireless communication standards are also possible.

The UE 106 may include one or more antennas for communicating using one or more wireless communication protocols according to one or more RAT standards, e.g. those previously mentioned above. In some embodiments, the UE 106 may share one or more parts of a receive chain and/or transmit chain between multiple wireless communication standards. The shared radio may include a single antenna, or may include multiple antennas (e.g., for MIMO) for performing wireless communications. Alternatively, the UE 106 may include separate transmit and/or receive chains (e.g., including separate antennas and other radio components) for each wireless communication protocol with which it is configured to communicate. As another alternative, the UE 106 may include one or more radios or radio circuitry which are shared between multiple wireless communication protocols, and one or more radios which are used exclusively by a single wireless communication protocol. For example, the UE 106 may include radio circuitries for communicating using either of LTE or CDMA2000 1xRTT or NR, and separate radios for communicating using each of Wi-Fi and BLUETOOTH™M. Other configurations are also possible.

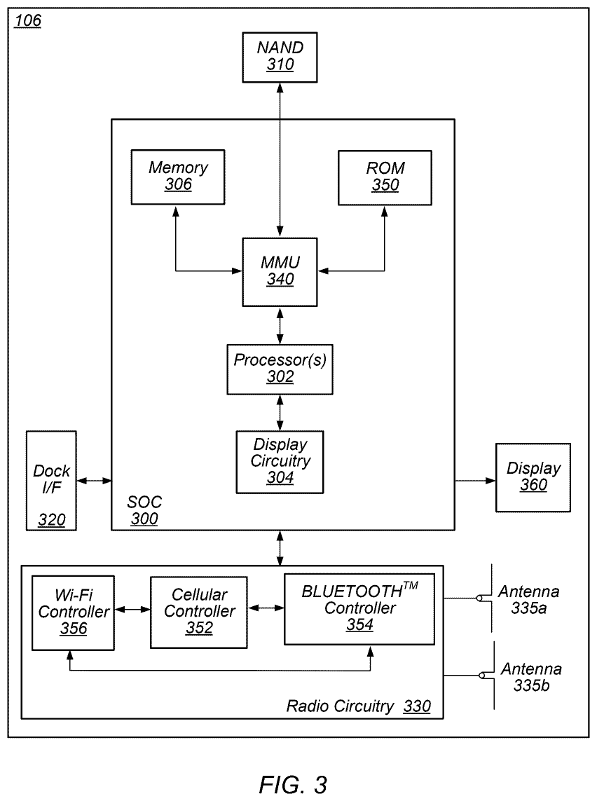

### FIG. 3—Block Diagram of an Exemplary UE

FIG. 3 illustrates a block diagram of an exemplary UE 106, according to some embodiments. As shown, the UE 106 may include a system on chip (SOC) 300, which may include various elements/components for various purposes. For example, as shown, the SOC 300 may include processor(s) 302 which may execute program instructions for the UE 106 and display circuitry 304 which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio circuitry 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to the computer system), the display 360, and wireless communication circuitry (e.g., for LTE, LTE-A, NR, CDMA2000, BLUETOOTH™, Wi-Fi, GPS, etc.). The UE device 106 may include at least one antenna (e.g. 335a), and possibly multiple antennas (e.g. illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna(s) 335. For example, the UE device 106 may use antenna(s) 335 to perform the wireless communication with the aid of radio circuitry 330. As noted above, the UE may be configured to communicate wirelessly using multiple wireless communication standards in some embodiments.

As further described herein, the UE 106 (and/or base station 102) may include hardware and software components for implementing methods for at least UE 106 to transmit reference signals according to various embodiments disclosed herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to implement communications by UE 106 to transmit reference signals according to various embodiments disclosed herein. Specifically, processor(s) 302 may be coupled to and/or may interoperate with other components as shown in FIG. 3 to facilitate UE 106 communicating in a manner that seeks to optimize RAT selection. Processor(s) 302 may also implement various other applications and/or end-user applications running on UE 106.

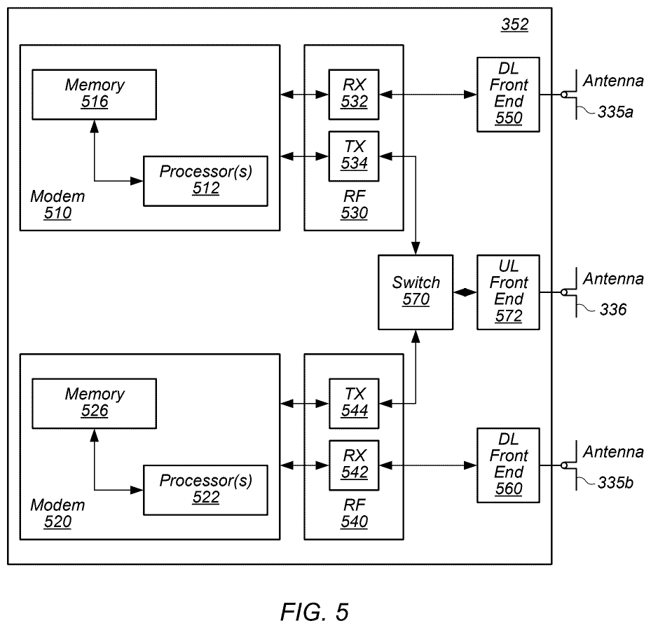

In some embodiments, radio circuitry 330 may include separate controllers dedicated to controlling communications for various respective RATs and/or RAT standards. For example, as shown in FIG. 3, radio circuitry 330 may include a Wi-Fi controller 356, a cellular controller (e.g. LTE and/or NR controller) 352, and BLUETOOTH™ controller 354, and according to at least some embodiments, one or more or all of these controllers may be implemented as respective integrated circuits (ICs or chips, for short) in communication with each other and with SOC 300 (e.g. with processor(s) 302). For example, Wi-Fi controller 356 may communicate with cellular controller 352 over a cell-ISM link or WCI interface, and/or BLUETOOTH™ controller 354 may communicate with cellular controller 352 over a cell-ISM link, etc. While three separate controllers are illustrated within radio circuitry 330, other embodiments may have fewer or more similar controllers for various different RATs and/or RAT standards that may be implemented in UE device 106. For example, at least one exemplary block diagram illustrative of some embodiments of cellular controller 352 is shown in FIG. 5 and will be further described below.

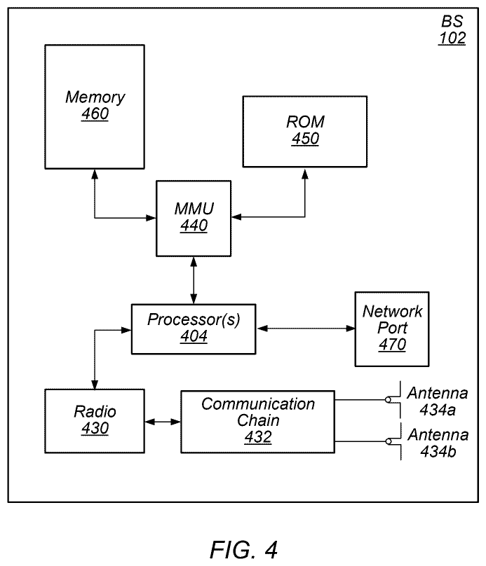

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434a, and possibly multiple antennas (e.g. illustrated by antennas 434a and 434b), for performing wireless communication with mobile devices and/or other devices. Antennas 434a and 434b are shown by way of example, and base station 102 may include fewer or more antennas. Overall, the one or more antennas, which may include antenna 434a and/or antenna 434b, are collectively referred to as antenna 434 or antenna(s) 434. Antenna(s) 434 may be configured to operate as a wireless transceiver and may be further configured to communicate with UE devices 106 via radio circuitry 430. The antenna(s) 434 communicates with the radio 430 via communication chain 432. Communication chain 432 may be a receive chain, a transmit chain or both. The radio circuitry 430 may be designed to communicate via various wireless telecommunication standards, including, but not limited to, LTE, LTE-A, 5G-NR (NR) WCDMA, CDMA 2000, etc. The processor(s) 404 of the base station 102 may be configured to implement part or all of the methods described herein, e.g., by executing program instructions stored on a memory medium (e.g., a non-transitory computer-readable memory medium). Alternatively, the processor(s) 404 may be configured as a programmable hardware element(s), such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network(s), e.g. it may include at least one Ethernet port, and radio 430 may be designed to communicate according to the Wi-Fi standard.

### FIG. 5—Exemplary Cellular Communication Circuitry

FIG. 5 illustrates an exemplary simplified block diagram illustrative of cellular controller 352, according to some embodiments. It is noted that the block diagram of the cellular communication circuitry of FIG. 5 is only one example of a possible cellular communication circuit; other circuits, such as circuits including or coupled to sufficient antennas for different RATs to perform uplink activities using separate antennas, or circuits including or coupled to fewer antennas, e.g., that may be shared among multiple RATs, are also possible. According to some embodiments, cellular communication circuitry 352 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 352 may couple (e.g., communicatively; directly or indirectly) to one or more antennas, such as antennas 335a-b and 336 as shown. In some embodiments, cellular communication circuitry 352 may include dedicated receive chains (including and/or coupled to (e.g., communicatively; directly or indirectly) dedicated processors and/or radios) for multiple RATs (e.g., a first receive chain for LTE and a second receive chain for 5G NR). For example, as shown in FIG. 5, cellular communication circuitry 352 may include a first modem 510 and a second modem 520. The first modem 510 may be configured for communications according to a first RAT, e.g., such as LTE or LTE-A, and the second modem 520 may be configured for communications according to a second RAT, e.g., such as 5G NR.

As shown, the first modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, the second modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 352 receives instructions to transmit according to the first RAT (e.g., as supported via the first modem 510), switch 570 may be switched to a first state that allows the first modem 510 to transmit signals according to the first RAT (e.g., via a transmit chain that includes transmit circuitry 534 and UL front end 572). Similarly, when cellular communication circuitry 352 receives instructions to transmit according to the second RAT (e.g., as supported via the second modem 520), switch 570 may be switched to a second state that allows the second modem 520 to transmit signals according to the second RAT (e.g., via a transmit chain that includes transmit circuitry 544 and UL front end 572).

As described herein, the first modem 510 and/or the second modem 520 may include hardware and software components for implementing any of the various features and techniques described herein. The processors 512, 522 may be configured to implement part or all of the features described herein, e.g., by executing program instructions stored on a memory medium (e.g., a non-transitory computer-readable memory medium). Alternatively (or in addition), processors 512, 522 may be configured as a programmable hardware element, such as an FPGA (Field Programmable Gate Array), or as an ASIC (Application Specific Integrated Circuit). Alternatively (or in addition) the processors 512, 522, in conjunction with one or more of the other components 530, 532, 534, 540, 542, 544, 550, 570, 572, 335 and 336 may be configured to implement part or all of the features described herein.

In addition, as described herein, processors 512, 522 may include one or more components. Thus, processors 512, 522 may include one or more integrated circuits (ICs) that are configured to perform the functions of processors 512, 522. In addition, each integrated circuit may include circuitry (e.g., first circuitry, second circuitry, etc.) configured to perform the functions of processors 512, 522.

In some embodiments, the cellular communication circuitry 352 may include only one transmit/receive chain. For example, the cellular communication circuitry 352 may not include the modem 520, the RF front end 540, the DL front end 560, and/or the antenna 335b. As another example, the cellular communication circuitry 352 may not include the modem 510, the RF front end 530, the DL front end 550, and/or the antenna 335a. In some embodiments, the cellular communication circuitry 352 may also not include the switch 570, and the RF front end 530 or the RF front end 540 may be in communication, e.g., directly, with the UL front end 572.

### Device-to-Device and Sidelink Communications

Device-to-device (D2D) communication refers to mobile devices, e.g., user equipment devices (UEs) directly communicating with each other without transferring data through a base station (BS) or other higher-level network infrastructure. D2D communication plays a crucial role in enhancing the coverage and transmission capacity of cellular and D2D communications. One example of D2D communications was provided above with respect to FIG. 1, in which UEs 106D and 106E may represent vehicles communicating directly with each other. Various embodiments of vehicles communicating with each other as exemplified in FIG. 1 may be in the context of vehicle-to-everything (V2X) communications which cover D2D communications, such as the communications specified by certain versions of the 3GPP standard. D2D-enabled cellular networks may make provisions for D2D users to share spectrum resources in two different ways. In-band D2D communications may take place over the licensed spectrum while out-band D2D communication may take place over the unlicensed spectrum. In-band D2D may be further divided into two categories, an underlay category in which D2D users share the same frequency resources used by cellular users, and an overlay category in which both network-bases and D2D communications use orthogonal spectrum resources.

As mentioned above, in D2D communications, e.g., cellular wireless communications, sidelink communication (also referred to as communication over a PC5 link, where PC5 link refers to sidelink) represents the communication mechanism between devices that is not carried through a base station, e.g. it is not carried through eNB/gNB. Accommodation of such communication between devices (or between UEs/PUEs) includes a physical layer design featuring minimal design changes with respect to previous implementations.

### Sidelink Positioning

Device positioning, e.g., determining the position/geolocation of a mobile device, has become an integral part of wireless communications. Various protocols and services have been introduced to aid with device positioning. For example, the radio resource location services (LCS) protocol (RRLP) has been used in cellular networks to exchange messages between a mobile device and a Serving Mobile Location Center (SMLC) in order to provide geolocation information (the SMLC is a network element that typically resides in a base station controller and calculates a network-based location of mobile devices). Similarly, Proximity Services (ProSe) is a D2D technology that allows mobile devices to detect each other and to communicate directly. ProSe relies on the sidelink communications for direct connectivity between devices, and offers several distinct benefits including better scalability, manageability, privacy, security and battery-efficiency.

Sidelink positioning is expected to be incorporated into release 18 (R18) of the 3GPP standard, with support for ranging functionality (e.g., distance measurements between mobile devices or UEs communicating via sidelink) and estimation of absolute coordinates (using sidelink signals from multiple UEs). Specifications regarding sidelink positioning in NR systems are being considered for:
SL Positioning Reference Signal (PRS) for support of sidelink positioning such that the SL-PRS uses a comb-based (not precluding a full resource-element, RE, mapping pattern) frequency domain structure and a pseudorandom-based sequence where the existing sequence of DL-PRS is used as a starting point. This includes specification of support for SL-PRS bandwidths of up to 100 MHz in FR1 spectrum. (The SL-PRS transmission in FR2 is not precluded, but no specifications for FR2 specific aspects are currently under consideration);
Measurements to support round trip time (RTT)-type solutions using SL, SL-angle of arrival (AoA), and SL time difference of arrival (SL-TDOA);
Procedures for transmit power control for SL-PRS transmissions based at least on open loop power control (OLPC);
Signaling and associated UE behavior for support of unicast, groupcast (not including many to one) and broadcast of SL-PRS transmissions;
Reporting signaling, and procedures to facilitate support of SL positioning in all coverage scenarios and for PC5-only and joint PC5-Uu scenarios (where Uu refers to the communication channel(s) between a base station and UE). This involves specifying the protocol and procedures for SL positioning between UEs (protocol for Sidelink positioning procedures (SLPP), and specifying the protocol and procedures for SL positioning between UEs and Link Management Function (LMF);
Signaling to Next Generation Radio Access Network (NG-RAN) for sidelink positioning and ranging service authorizations as needed;
Corresponding new core requirements, as well as the impact on the existing specification, including Radio Resource Management (RRM) measurements and procedures; and
Support for resource allocations for SL-PRS, including network-centric SL-PRS resource allocation and autonomous UE SL-PRS resource allocation. In the case of autonomous resource allocation, the UE does not rely on the network/base station for the SL-PRS specification and SL-PRS resource allocation, which may instead be determined by the UE itself.

Regarding autonomous SL-PRS resource allocation, specifications are being considered for:
Resource selection mechanism for SL-PRS, including sensing-based resource allocation and/or random resource selection;
Inter-UE coordination (IUC);
Congestion control mechanisms for SL-PRS;
Resource allocation for shared resource pool with Rel-16/17/18 sidelink communications (where shared resources are used for both SL-PRS transmission and other SL transmissions) and dedicated resource pool for SL-PRS (where resources are dedicated specifically to transmitting SL-PRS);
For SL positioning resource (pre-)configuration in a shared resource pool with Rel-16/17/18 sidelink communications, maintaining backward compatibility with legacy Rel-16/17 UEs.

Currently, specifications have been set for the following:
For a dedicated resource pool for SL positioning, channel(s) included in the dedicated resource pool may optionally be:
   Option 1—No other channel is included beyond SL-PRS,
   Option 2—Physical Sidelink Shared Channel (PSCCH) which carries Sidelink Control Information (SCI) associated with SL-PRS transmission(s) is included,
   Option 3—PSCCH which carries SCI associated with SL-PRS transmission(s) and PSSCH associated with SL-PRS transmission(s) are included.
Details regarding the above, as well the definition of PSSCH associated with SL-PRS transmission(s) have not been finalized.
For SL signaling of the reservation/indication of SL-PRS resource(s) for a dedicated resource pool and shared resource pool (if supported) for positioning, the following has been defined:
   SCI can be used for reserving/indicating one or more SL-PRS resource(s). However, this does not mean that only SCI may be used. Higher layer signaling may also be used for indicating at least a part of the SL-PRS configuration. It has not yet been finalized whether the SCI is a single stage SCI or two stage SCI. Similarly, the specifics and details of the higher layer signaling, e.g., the possibility of a SL Media Access Control (MAC) Control Element (CE), SL-MAC-CE, or other higher-layer signaling reservation/indication, have also not yet been finalized.

### Design Considerations for Autonomous SL-PRS Resource Allocation

As noted above, at least two different resource allocation solutions are considered for SL-PRS resource allocation, one of which is an autonomous UE SL-PRS resource allocation solution. Two different approaches may be considered for the autonomous UE SL-PRS resource allocation, or autonomous SL-PRS resource allocation, for short. According to a first approach, a transmitting (TX) UE may receive, e.g., from an assisting (AT) UE, information indicative of SL-PRS resources to be considered/used by the TX UE. These SL-PRS resources may include preferred SL-PRS resources for use by the TX UE, and/or they may include non-preferred resources not for use by the TX UE. According to a second approach, the TX UE may first attempt to reserve SL-PRS resources (e.g., resources identified by the TX UE, e.g., via its own sensing/measurements) by transmitting a reservation indication/request for those resources to an AT UE.

It should be noted that “IUC” is also used herein as a shorthand for “IUC SL communication(s)”. For example, “transmitting/receiving an IUC” means transmitting/receiving an IUC SL communication, e.g., transmitting an IUC indication or IUC information, and the like. In that context, “IUC for SL-PRS” or “IUC related to SL-PRS” refers to IUC SL communications associated with or about SL-PRS support and/or SL-PRS resource support. An IUC for SL-PRS may include, for example, IUC requests, IUC indications, IUC information, and the like, all relating to (or associated with) SL-PRS support and/or SL-PRS resource support. Similarly, “IUC for SL data” refers to IUC SL communications relating to (or associated with) SL data transmissions. In general, IUC SL communications (or IUCs) may be used for (or may be associated with) a variety of SL functionalities, including SL positioning. Furthermore, “SL-PRS resource(s)” refers to wireless resource(s) used by a UE for transmitting an SL-PRS.

System design for the first approach may address the following issues:
procedure for the UE transmitting an SL-PRS,
procedure for an assisting (or helping) UE to transmit an IUC for SL-PRS,
slot structure to support an IUC for SL-PRS,
contents and container of an IUC for SL-PRS request,
contents and container of an IUC for SL-PRS indication,
procedure for the AT UE to determine/identify preferred and non-preferred SL-PRS resource(s), and
procedure for a TX UE on how to select the SL-PRS resource(s) to use, based on the determined preferred and/or non-preferred SL-PRS resource(s).

System design for the second approach may address the following issues:
procedure for the UE transmitting an SL-PRS,
procedure for an AT UE to transmit an IUC for SL-PRS,
format of an IUC indication,
procedure for the AT UE to determine/identify an SL-PRS resource conflict,
procedure for the AT UE to determine which UE to transmit the IUC for SL-PRS to, and
procedure to prioritize the transmission/reception of IUC for SL-PRS vs. SL Hybrid Automatic Repeat Request (HARQ) and/or IUC for SL data.

### SL-PRS Resource Allocation: First Approach With Request-based Resource Allocation

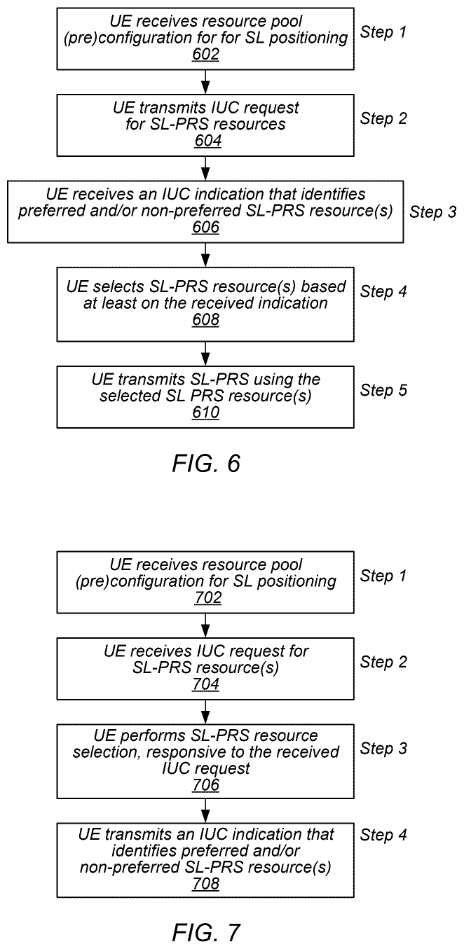

FIG. 6 shows an exemplary flow diagram of a request-based IUC SL positioning procedure from the perspective of a TX UE, while FIG. 7 shows an exemplary flow diagram of a request-based IUC SL positioning procedure from the perspective of an AT UE.

As shown in FIG. 6, the TX UE receives resource pool (pre)configuration for SL positioning (Step 1, 602), then transmits an IUC request for SL-PRS resource(s) (Step 2, 604.) The TX UE may then receive an IUC indication that identifies preferred and/or non-preferred SL-PRS resource(s) (Step 3, 606), and may select the SL-PRS resource(s) for transmitting the SL-PRS, based at least on the received indication (Step 4, 608). Finally, the TX UE may transmit the SL-PRS using the selected SL-PRS resource(s) (Step 5, 610).

As shown in FIG. 7, the AT UE may receive resource pool (pre)configuration for SL positioning (Step 1, 702), then receive an IUC request for SL-PRS resource(s), e.g., from a TX UE (Step 2, 704). The AT UE may then perform SL-PRS resource selection, responsive to the received IUC request (Step 3, 706), and transmit an IUC indication that identifies preferred and/or non-preferred SL-PRS resource(s) (Step 4, 708).

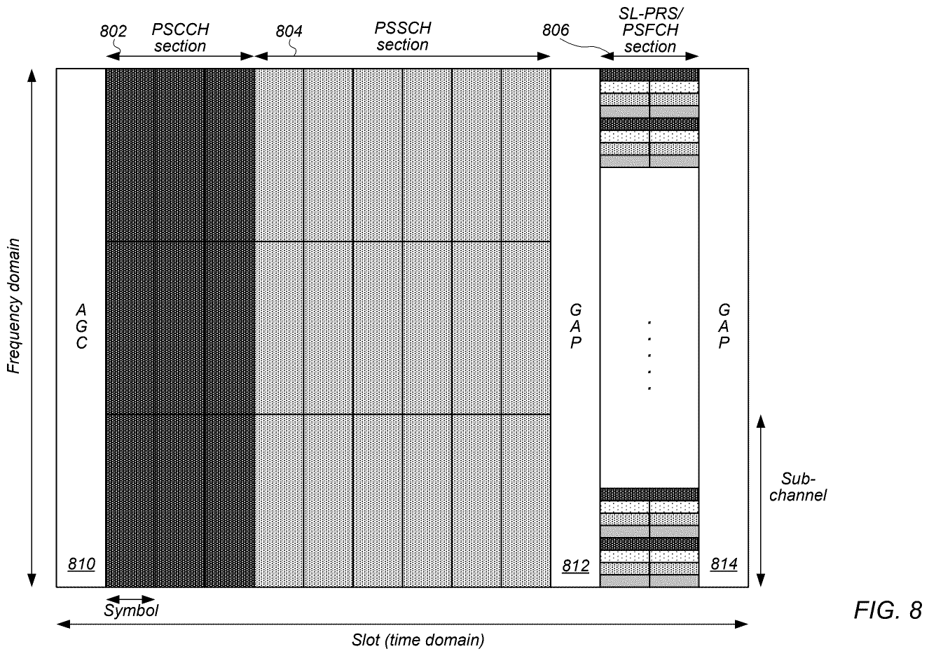

For Step 1 of both flow diagrams (referring to 602 and 702, respectively), a supporting resource pool slot structure may be configured. FIG. 8 shows a diagram of an exemplary slot structure that supports resource pool (pre)configuration for SL positioning. FIG. 8 provides an illustration for a single exemplary slot. According to a first (i) alternative, the resource pool may include PSCCH resources (802), PSSCH resources (804) and Physical Sidelink Feedback Channel (PSFCH)/SL-PRS resources (806). According to a second (ii) alternative, the resource pool may only include PSCCH, PSSCH and SL-PRS (in this case 806 includes only SL-PRS resources). According to a third (iii) alternative, the resource pool may only include PSCCH and SL-PRS resources (in this case, 804 is not included and 806 includes only SL-PRS resources). The aforementioned alternatives may further be detailed as follows.
i. PSFCH and SL-PRS may be frequency division multiplexed (FDM-d), or time division multiplexed (TDM-d) sharing the last two symbols of a slot (excluding automatic gain control, AGC, symbol), as shown in FIG. 8. For TDM-d sharing, some slots may have PSFCH resources, while other slots may have SL-PRS resources. An additional GAP symbol 812 may or may not be included in the middle of a slot having SL-PRS resources. If no GAP symbol is included, then PSCCH/PSSCH/SL-PRS may be from the same UE. The IUC may be transmitted via PSSCH (or optionally via PSCCH).
ii. PSFCH resources are not included in the resource pool. The IUC may be transmitted via PSSCH (or optionally via PSCCH).
iii. The IUC (including both IUC request and IUC indication) may be transmitted via PSCCH.

For Step 2 of both flow diagrams (referring to 604 and 704, respectively), the IUC request (for SL-PRS resources) may include:
SL-PRS priority information, e.g., what is the SL-PRS priority for the TX UE;
SL-PRS periodicity information, e.g., in case of periodically transmitted SL-PRSs, what is the periodicity of the SL-PRS;
Information identifying the number of (available) SL-PRS resources;
Resource selection window location, e.g., a time window defining an upper and lower bound of the resources. The resource selection window may be defined using at least two different formats. According to a first format, it may be defined by a starting slot index and window duration (with the window duration represented as a number of slots). According to a second format, it may be defined by a starting slot index and an ending slot index, with the starting slot index corresponding to first direct frame number (DFN), the ending slot index corresponding to a second DFN, and the additional slot indexes corresponding to respective DFNs within the range spanning between the first DFN and the second DFN; and
Resource type, which may indicate whether the TX UE wishes to receive identification of preferred SL-PRS resources and/or identification of non-preferred SL-PRS resources.

The IUC request container may be a MAC-CE, with the logical channel priority of the MAC-CE matching the SL-PRS priority. Alternatively, the IUC container may be SCI, optionally configured on top of the MAC-CE. In case of 2-stage SCI, the IUC request may be carried according to SCI 2-C or a new SCI stage 2 format.

For Step 3 of the flow diagram of FIG. 6 (referring to 606), the IUC indication may include information identifying:
SL-PRS priority, e.g., indicating the priority for the TX UE to use in selection of preferred resources;
List of SL-PRS resources, where each resource may be defined by:
   time resources, which may be defined by a first resource location in a combination of the SL-PRS resources, and/or by a reference slot location, and
   frequency resources, which may be defined by a resource index within a slot or by a starting SL-PRS resource index and the number of SL-PRS resources (identifying how many SL-PRS resources there are);
Periodicity for periodic SL-PRSs; and
Resource type, which may indicate whether the list of SL-PRS resources includes preferred SL-PRS resources and/or non-preferred SL-PRS resources.

The IUC indication container may be a MAC-CE, with the logical channel priority of the MAC-CE matching the SL-PRS priority. Alternately, the IUC indication container may be SCI, optionally configured on top of the MAC-CE. In case of a 2-stage SCI, the IUC indication may be carried in SCI 2-C or a new SCI stage 2 format. In general, the IUC indication may have the same SCI format as the IUC request, with an indicator to distinguish between an IUC request and an IUC indication.

For step 4 of the flow diagram of FIG. 6 (referring to 608), the TX UE may select the resources based on whether the SL-PRS resources are preferred SL-PRS resources or non-preferred SL-PRS resources.
In case of preferred SL-PRS resources, S_{P}, the TX UE may obtain candidate SL-PRS resources, S_{A}, based on its own sensing, identify intersecting resources common to both S_{A} and S_{P}, then select (e.g., randomly) the SL-PRS resources from among the intersecting resources. If the number of intersecting SL-PRS resources is not enough, the TX UE may additionally select (e.g., randomly) SL-PRS resources from S_{A}.
In case of non-preferred SL-PRS resources, S_{NP}, the TX UE may exclude from S_{A} all the resources that are included in S_{NP}.

For step 3 of the flow diagram of FIG. 7 (referring to 706), the AT UE may perform the SL-PRS selection according to at least the following criteria/considerations:
The SL-PRS resource selection window may be based on the TX UE's IUC request;
The SL-PRS sensing window may be (pre)configured by the resource pool;
Preferred SL-PRS resources, S_{P}, may be selected/identified via a resource selection procedure performed with an initial RSRP threshold, where the RSRP threshold increase step and priority may be based on resource pool (pre)configuration or they may be indicated in the IUC request;
Non-preferred SL-PRS resources, S_{NP}, may be identified as follows:
   If resources are reserved by a UE other than the TX UE (e.g., reserved by UE-C) and the RSRP measurement of the signal from the UE-C is greater than a specified threshold value, then the resources reserved by the UE-C may be identified as non-preferred SL-PRS resources, e.g., to avoid collision with UE-C transmission(s). The specified threshold may be set/established based on data priority;
   If the AT UE is a receiving UE of SL-PRS from a UE other than the TX UE (e.g., receiving from UE-C), and the RSRP measurement from the UE-C is lower than a specified threshold, then the resources reserved by the UE-C may be identified as non-preferred SL-PRS resources, e.g., to ensure proper reception of the SL-PRS from the UE-C by the AT UE. Again, the specified threshold may be set/established based on data priority; and
   If the AT UE is a receiving UE of SL-PRS from the TX UE, and the AT UE is conducting SL transmissions in the same slot, then the SL-PRS resources for that slot may be identified as non-preferred SL-PRS resources, e.g., to avoid collision with between the SL-PRS from the TX UE and the SL transmissions of the AT UE.

### SL-PRS Resource Allocation: First Approach With Condition-Based Resource Allocation

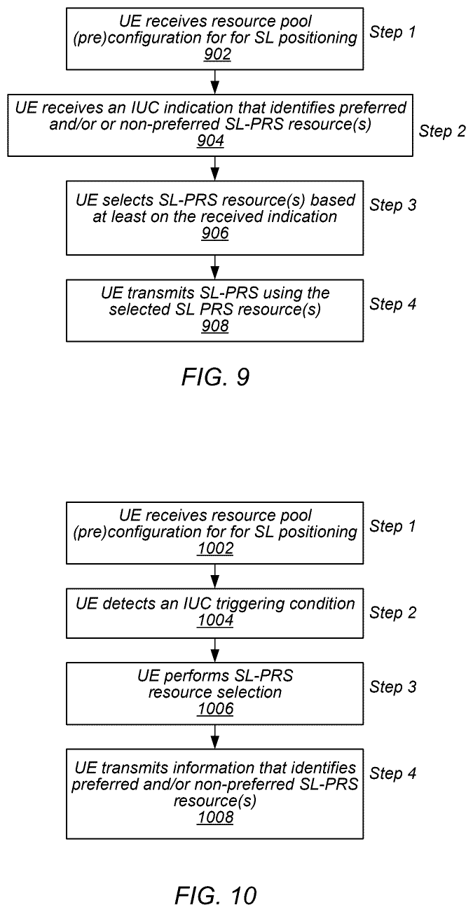

FIG. 9 shows an exemplary flow diagram of a condition-based IUC SL positioning procedure from the perspective of a TX UE, while FIG. 10 shows an exemplary flow diagram of a condition-based IUC SL positioning procedure from the perspective of an AT UE.

As shown in FIG. 9, the TX UE receives resource pool (pre)configuration for SL positioning (Step 1, 902), and then receives an IUC indication identifying preferred or non-preferred SL-PRS resource(s) (Step 2, 904). The TX UE may select the SL-PRS resources (for transmitting the SL-PRS) based at least on the received indication (Step 3, 906). Finally, the TX UE may transmit the SL-PRS using the selected SL-PRS resources (Step 4, 908).

As shown in FIG. 10, the AT UE may receive resource pool (pre)configuration for SL positioning (Step 1, 1002). The AT UE may subsequently detect an IUC triggering condition (Step 2, 1004), and perform SL-PRS resource selection, responsive to the detected IUC trigger condition (Step 3, 1006). The AT UE may then transmit information that identifies preferred and/or non-preferred SL-PRS resources (Step 4, 1008.)

For step 2 of the flow diagram of FIG. 10 (referring to 1004), the triggering conditions may include:
The (data) size indicated by the SL buffer status report (SL-BSR) is larger than a (pre)configured resource pool threshold;
The AT UE has sidelink data to be transmitted such that an IUC may be piggybacked on (e.g., included with) the sidelink data transmission; and
A UE-implementation-based condition.
   Condition-based SL-PRS resource allocation may be enabled/disabled per resource pool.

### SL-PRS Resource Allocation: Second Approach

As previously mentioned, a second approach for autonomous SL-PRS resource allocation may be based on a TX UE first identifying SL-PRS resources to use, and indicate via an IUC (indication) to an AT UE that it wishes to reserve those SL-PRS resources. The second approach may thereby include a mechanism to detect possible resource collision involving the SL-PRS resources the TX UE wishes to reserve, and provide an indication, e.g., via IUC indication to the TX UE, of these possible resource collisions to avoid any potential signaling issues when transmitting SL-PRSs.

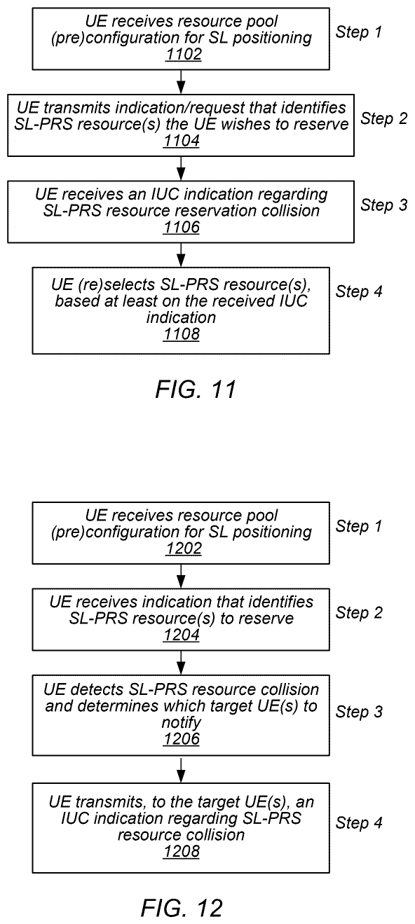

FIG. 11 shows an exemplary flow diagram of a reservation-based IUC SL positioning procedure (e.g., a procedure involving an SL-PRS resource reservation request from a TX UE) from the perspective of a TX UE, while FIG. 12 shows an exemplary flow diagram of a reservation-based IUC SL positioning procedure from the perspective of an AT UE.

As shown in FIG. 11, the TX UE receives resource pool (pre)configuration for SL positioning (Step 1, 1102). The TX UE then transmits an indication that identifies SL-PRS resources that the TX UE wishes to reserve (Step 2, 1104). The TX UE may subsequently receive an IUC indication that includes information about (possible) SL-PRS resource reservation collisions involving the SL-PRS resources the TX UE wishes to reserve (Step 3, 1106). The TX UE may then (re)select the SL-PRS resources to use, based at least on the received IUC indication (Step 4, 1108). Though not shown, the TX UE may subsequently transmit the SL-PRS using the (re)selected SL-PRS resources.

As shown in FIG. 12, the AT UE may receive resource pool (pre)configuration for SL positioning (Step 1, 1202). The AT UE may subsequently receive an indication that identifies SL-PRS resources to reserve (Step 2, 1204). The AT UE may perform operations to detect any SL-PRS resource collision involving the SL-PRS resources to reserve, and may determine a target UE(s) to notify regarding a detected SL-PRS resource collision(s) (Step 3, 1206). The AT UE may then transmit, to the target UE(s), an IUC indication about any SL-PRS resource collision(s) involving the SL-PRS resources to reserve (Step 4, 1208).

For Step 1 of both flow diagrams (referring to 1102 and 1202, respectively), a supporting resource pool slot structure may be configured. Overall, the IUC for SL-PRS for the second approach may be carried via PSFCH. The IUC for SL-PRS may be frequency division multiplexed with SL-HARQ and/or IUC for SL data transmission. At least two different implementations may be considered:
i. A new (dedicated) bitmap may be designed to indicate the physical resource blocks (PRBs) allocated for IUC for SL-PRS.
ii. A combined bitmap may be designed to indicate the PRB allocation for IUC for SL-PRS and for IUC for SL data transmission.

Each IUC transmission for SL-PRS may be according to PUCCH format 0, with one (1) PRB with length-12 sequence, with a sequence cyclic shift equal to 0 (e.g., NACK only). This feature of the IUC for SL-PRS may be enabled/disabled per resource pool (pre)configuration.

For Step 2 of the flow diagram of FIG. 11 (referring to 1104), the TX UE may also indicate it has the capability of receiving an IUC transmission for SL-PRS. This may provide assistance to an AT UE in making a decision regarding which UE to transmit to (e.g., in 1206 of FIG. 12). For example, if a UE does not have the capability of receiving IUC for SL-PRS, the AT UE may not attempt to transmit an IUC for SL-PRS to that UE. This capability may be indicated via SCI. In some embodiments, the same bit in SCI stage 1 may be used to indicate this capability as the bit used to indicate capability for IUC for SL data.

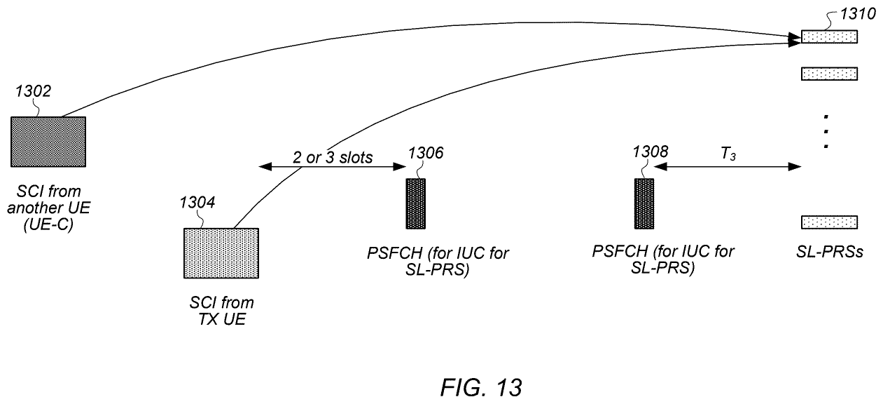

For step 3 of flow diagram of FIG. 11 (referring to 1106), the resource(s) for IUC for SL-PRS (using which the TX UE may receive the indication) may be organized as illustrated in FIG. 13. A first time-gap between PSCCH/PSSCH carrying SCI 1304 from a TX UE and PSFCH 1306 may be no less than 2 to 3 slots by resource pool (pre)configuration. A second time-gap between PSFCH 1308 and SL-PRS 1310 may be at least a specified duration, T₃. FIG. 13 also illustrates SCI 1302 being carried from another UE (UE-C), and TX UE and UE-C both attempting to reserve SL-PRS resources on which SL-PRS 1310 would be transmitted. The resource pool (pre)configuration may indicate which time-gap, the first time-gap and/or the second time-gap, may be used. Frequency resource mapping from PSCCH/PSSCH to PSFCH for IUC for SL-PRS may follow a similar rule as the resource mapping from PSCCH/PSSCH to PSFCH for HARQ-ACK. The IUC (indication) may be received according to the following signal prioritizations:
Prioritization between reception of IUC for SL-PRS, and transmission of SL-HARQ. The prioritization may be priority based (e.g., based on the respective priorities of the IUC for SL-PRS and the SL-HARQ), or it may always give priority to SL-HARQ, and/or it may be set by the resource pool (pre)configuration;
Prioritization between reception of IUC for SL-PRS, and transmission of IUC for SL data. The prioritization may be priority based (e.g., based on the respective priorities of the IUC for SL-PRS and the IUC for SL data), or it may always give priority to the IUC for SL data, and/or it may be set by the resource pool (pre)configuration. In case of multiple IUCs for SL data, the smallest priority value (e.g., corresponding to the highest priority) of the conflicting transport blocks (TBs) may be used;
Prioritization between reception of IUC for SL-PRS, and transmission of IUC for SL-PRS. The prioritization may be priority based (e.g., based on the respective priorities of the reception of IUC for SL-PRS and the transmission of IUC for SL-PRS), or it may always favor reception of IUC for SL-PRS, or it may always favor transmission of IUC for SL-PRS, and/or it may be set by the resource pool (pre)configuration. In case of multiple IUC for SL-PRS transmissions, the smallest priority value (e.g., corresponding to the highest priority) of the conflicting SL-PRSs may be used.

For step 4 of the flow diagram of FIG. 11 (referring to 1108), the reception of an IUC may also trigger resource reevaluation and/or preemption checking.

For step 3 of the flow diagram of FIG. 12 (referring to 1206), the AT UE may detect SL-PRS resource collision(s) when another UE (e.g., UE-C) seeks to reserve (or has already reserved) the same SL-PRS resource(s) that the TX UE seeks to reserve via 1104, as illustrated in FIG. 11. When considering absolute RSRP values, the AT UE may detect/identify that a resource collision exists when:
1. the AT UE is a recipient of the SL-PRS from the TX UE, and the RSRP associated with signaling of the UE-C's is larger than a specified threshold value; or
2. the AT UE is a recipient of the SL-PRS from the UE-C, and the RSRP associated with signaling of the TX UE is larger than a specified threshold value.

When considering relative RSRP values, the AT UE may detect/identify that a resource collision exists, when:
1. the AT UE is a recipient of the SL-PRS from the TX UE, and a difference—defined as the RSRP associated with signaling of the UE-C minus the RSRP associated with signaling of the TX UE—is larger than a specified threshold value; or
2. the AT UE is a recipient of the SL-PRS from the UE-C, and a difference—defined as the RSRP associated with signaling of the TX UE minus the RSRP associated with signaling of the UE-C—is larger than a specified threshold value.

The AT UE may determine which UE (e.g., TX UE or UE-C) to notify as follows:
If both the TX UE and the UE-C have the capability of receiving IUC for SL-PRS, then the UE with a higher priority value (e.g., corresponding to a lower priority) may be notified;
If one of the UEs does not have the capability of receiving IUC for SL-PRS, then the other UE may be notified;
If neither UE has the capability of receiving IUC for SL-PRS, then neither UE may be notified.
   The timeline of the notification(s) may be consistent with the timings illustrated in FIG. 13.

For step 4 of the flow diagram of FIG. 12 (referring to 1208), the IUC indication may be transmitted according to the following signal prioritizations:
Prioritization between transmission of IUC for SL-PRS, and transmission/reception of SL-HARQ. The prioritization may be priority based (e.g., based on the respective priorities of the IUC for SL-PRS and the SL-HARQ), or it may always give priority to SL-HARQ, and/or it may be set by the resource pool (pre)configuration;
Prioritization between transmission of IUC for SL-PRS, and transmission/reception of IUC for SL data. The prioritization may be priority based (e.g., based on the respective priorities of the IUC for SL-PRS and the IUC for SL data), or it may always give priority to the IUC for SL data, and/or it may be set by the resource pool (pre)configuration. In case of multiple IUCs for SL data, the smallest priority value (e.g., corresponding to the highest priority) of the conflicting transport blocks (TBs) may be used. In case of multiple IUCs for SL-PRS, the smallest priority value (e.g., corresponding to the highest priority) of the conflicting SL-PRS may be used;
Prioritization between transmission of IUC for SL-PRS, and reception of IUC for SL-PRS. The prioritization may be priority based (e.g., based on the respective priorities of the reception of IUC for SL-PRS and the transmission of IUC for SL-PRS), or it may always favor reception of IUC for SL-PRS, or it may always favor transmission of IUC for SL-PRS, and/or it may be set by the resource pool (pre)configuration. In case of multiple IUC for SL-PRS transmissions, the smallest priority value (e.g., corresponding to the highest priority) of the conflicting SL-PRSs may be used).
Prioritization between two different IUC for SL-PRS transmissions may be priority based (as also indicated above with regard to multiple IUC for SL-PRS transmissions).

### Embodiments of Autonomous SL-PRS Resource Allocation Procedures

In some embodiments, a first device may receive first information identifying a resource pool for sidelink (SL) positioning communications. The first device may subsequently receive, from a second device via inter-device-coordination (IUC) SL communication using one or more resources from the identified resource pool, an indication that includes second information about sidelink positioning reference signal (SL-PRS) resources. The first device may then select one or more SL-PRS resources based at least on the received second information, and transmit an SL-PRS using the selected one or more SL-PRS resources.

The resource pool may include physical sidelink control channel (PSCCH) resources, physical sidelink shared channel (PSSCH) resources, physical sidelink feedback channel (PSFCH) resources, and/or SL-PRS resources. When the resource pool includes PSFCH resources and SL-PRS resources, the PSFCH resources and the SL-PRS resources may be frequency division multiplexed. Alternatively, they may be time division multiplexed, sharing the last two symbols of a slot. In some embodiments, a first set of slots may have PSFCH resources, and a second set of slots—different from the first set of slots—may have SL-PRS resources.

### Request-Based Procedures

In some embodiments, the first device may transmit, to the second device via IUC SL communication prior to receiving the indication, a request for SL-PRS resources, and may receive the indication responsive to the request. In that case, the second information may identify one or more preferred SL-PRS resources and/or one or more non-preferred SL-PRS resources, and the first device may select the one or more SL-PRS resources by selecting from among the one or more preferred SL-PRS resources and/or excluding the one or more non-preferred SL-PRS resources. The one or more preferred SL-PRS resources may have been identified according to a resource selection procedure using an initial Reference Signal Received Power (RSRP) threshold value, and an RSRP threshold increase step and priority.

The one or more non-preferred SL-PRS may include
resources reserved by a third device, when a Reference Signal Received Power (RSRP) measurement associated with the third device is greater than a specified first threshold value,
resources reserved by a fourth device, when the second device is a receiving device of an SL-PRS transmitted by the fourth device and an RSRP measurement associated with the fourth device is lower than a specified second threshold value, or
resources reserved for a given slot, when the second device is a receiving device of the SL-PRS transmitted by the first device and the second device is conducting SL communications in the given slot.

The request may include SL-PRS priority information, SL-PRS periodicity information, a number identifying how many SL-PRS resources are requested, a resource selection window, and/or an indication of type of SL-PRS resource requested, where a first type of SL-PRS resource is a preferred SL-PRS resource and a second type of SL-PRS resource is a non-preferred SL-PRS resource. The resource selection window may be defined by a starting slot index and a window duration represented as a number of slots, or a starting slot index and an ending slot index, with the starting slot index and the ending slot index each corresponding to a different respective direct frame number. The request and/or indication may be transmitted in a media access control (MAC) control element (MAC-CE), or in sidelink control information (SCI). In case of the latter, the SCI may be configured on top of the MAC-CE. Furthermore, when the request is transmitted in SCI, the request may be carried according to a SCI-2-C format in case of 2-stage SCI, or it may be carried in an alternative SCI stage 2 format different from the SCI-2-C format.

In some embodiments, the second information may include SL-PRS priority information for the first device, SL-PRS periodicity information for the first device, and/or a list of SL-PRS resources. For the list of SL-PRS resources, the second information may further include the type of the SL-PRS resources included in the list of SL-PRS resources, e.g., preferred SL-PRS resources or non-preferred SL-PRS resources. The SL-PRS resources included in the list of SL-PRS resources may defined by time resources and frequency resources. The time resources may be defined by a first resource location in a combination of the SL-PRS resources included in the list, or by a reference slot location. The frequency resources may be defined by a resource index within a slot, or by a starting SL-PRS resource index and a number identifying how many SL-PRS resources are included in the list of SL-PRS resources.

In some embodiments, the indication may be transmitted in a MAC-CE, with a logical channel priority of the MAC-CE matching an SL-PRS priority for the first device. In some embodiments, the indication may be transmitted in SCI, with the SCI configured on top of the MAC-CE. When the indication is transmitted in SCI, in case of 2-stage SCI the indication may be carried according to SCI-2-C format or an alternative SCI stage 2 format different from the SCI-2-C format.

### Condition-Based Procedures

In some embodiments, the first device may receive the indication in response to an IUC triggering condition. The IUC triggering condition may be any one or more of the following:
a data size indicated by an SL buffer status report (SL BSR) is larger than a configured resource pool threshold,
it is possible for the second device to include IUC SL communications with SL data transmissions performed by the second device, or
a predefined device-implementation-based condition.

### Reservation-Based Procedures

In some embodiments, the first device may transmit to the second device via IUC SL communication prior to receiving the indication, a reservation request to have specified SL-PRS resources reserved for the first device. The first device may then receive the indication based on the reservation request. For reservation-based procedures, IUC SL communications relating to SL-PRS may be transmitted over a physical sidelink feedback channel (PSFCH). In some embodiments, the IUC SL communications relating to SL-PRS may be frequency division multiplexed with SL hybrid automatic repeat request (SL HARQ) transmissions and/or IUC SL communications relating to SL data transmission. Physical resource blocks (PRBs) allocated for the IUC SL communications relating to SL-PRS may be indicated by a dedicated bitmap indicating PRBs allocated for IUC SL communications relating to SL-PRS, or by a combined bitmap indicating respective PRBs allocated for IUC SL communications relating to SL-PRS and IUC SL communications relating to SL data transmission.

In some embodiments, the second information may inform the first device of one or more SL-PRS resource reservation collisions involving the specified SL-PRS resources. The one or more SL-PRS resource reservation collisions may occur when the specified SL-PRS resources are also reserved by a third device. The specified SL-PRS resources may be involved in the one or more SL-PRS resource reservation collisions when:
the second device is a recipient of an SL-PRS transmitted by the first device, and a Reference Signal Received Power (RSRP) associated with the third device is larger than a first threshold value; and/or
the second device is a recipient of an SL-PRS transmitted by the third device, and an RSRP associated with the first device is larger than a second threshold value; and/or
the second device is a recipient of an SL-PRS transmitted by the first device, and a difference—defined as an RSRP associated with the third device minus an RSRP associated with the first device—is larger than a third threshold value; and/or
the second device is a recipient of an SL-PRS transmitted by the third device, and a difference—defined as an RSRP associated with first device minus an RSRP associated with the third device—is larger than a fourth threshold value.

In some embodiments, the indication may be received no sooner than a first specified length of time following transmission by the first device on a physical sidelink channel and/or no later than a second specified length of time prior to transmission of an SL-PRS by the first device. In addition, the indication may be received according to signal prioritization defined by:
prioritization between reception of IUC SL communication relating to SL-PRS, and transmission of SL-HARQ; and/or
prioritization between reception of IUC SL communication relating to SL-PRS, and transmission of IUC SL communication relating to SL data; and/or
prioritization between reception of IUC SL communication relating to SL-PRS, and transmission of IUC SL communication relating to SL-PRS.

The first device may provide to the second device prior to receiving the indication, a second indication that the first device has a capability of receiving IUC SL communications relating to SL-PRS. The second indication may be provided as sidelink control information.

### Additional Embodiments of Autonomous SL-PRS Resource Allocation Procedures

In some embodiments, a first device may receive first information identifying a resource pool for sidelink (SL) positioning communications. The first device may generate second information about sidelink positioning reference signal (SL-PRS) resources, the second information for use by a second device in selecting one or more SL-PRS resources for transmitting an SL-PRS. The first device may transmit, to the second device via inter-device-coordination (IUC) SL communication using one or more resources from the identified resource pool, an indication that includes the second information.

### Request-Based Procedures

In some embodiments, the first device may receive from the second device via IUC SL communication prior to the first device transmitting the indication, a request for SL-PRS resources, and may transmit the indication responsive to the request. The second information may identify one or more preferred SL-PRS resources and/or one or more non-preferred SL-PRS resources.

Generating the second information may include selecting the one or more preferred SL-PRS resources and/or the one or more non-preferred SL-PRS resources. Selecting the one or more preferred SL-PRS resources and/or the one or more non-preferred SL-PRS resources may include selecting an SL-PRS resource window based on the request or based on a preconfigured SL-PRS resource window. The one or more preferred SL-PRS resources may be selected according to a resource selection procedure using an initial Reference Signal Received Power (RSRP) threshold value, and RSRP threshold increase step and priority. Selecting the one or more non-preferred SL-PRS resources may include identifying a given SL-PRS resource as a non-preferred SL-PRS resource when:
the given resource is reserved by a third device, and a Reference Signal Received Power (RSRP) measurement associated with the third device is greater than a specified first threshold value; and/or
the given resource is reserved by a fourth device, the first device is a receiving device of an SL-PRS transmitted by the fourth device, and an RSRP measurement associated with the fourth device is lower than a specified second threshold value; and/or
the given resource is reserved for a given slot, the first device is a receiving device of the SL-PRS transmitted by the first device, and the first device is conducting SL communications in the given slot.

### Condition-Based Procedures

In some embodiments, the first device may transmit the indication in response to detecting an IUC triggering condition. Detection of the IUC triggering condition may include detecting
that a data size indicated by an SL buffer status report (SL BSR) is larger than a configured resource pool threshold, and/or
that it is possible for the first device to include IUC SL communications with SL data transmissions performed by the first device, and/or
a predefined device-implementation-based condition.

The first device may select the preferred and/or non-preferred SL-PRS resources in response to detecting the IUC trigger condition, and may include a list of the selected preferred SL-PRS resources and/or non-preferred SL-PRS resources in the second information.

### Reservation-Based Procedures

In some embodiments, the first device may receive from the second device via IUC SL communication prior to transmitting the indication, a request to have specified SL-PRS resources reserved for the second device, and may transmit the indication based on the request.

The first device may identify one or more SL-PRS resource reservation collisions involving the specified SL-PRS resources, and may include, in the second information, collision information about the one or more SL-PRS resource reservation collisions involving the specified SL-PRS resources. Identifying the one or more SL-PRS resource reservation collisions involving the specified SL-PRS resources may include determining that the specified SL-PRS resources are also reserved by a third device, and may further include determining that:
the first device is a recipient of an SL-PRS transmitted by the second device, and a Reference Signal Received Power (RSRP) associated with the third device is larger than a first threshold value; and/or
the first device is a recipient of an SL-PRS transmitted by the third device, and an RSRP associated with the second device is larger than a second threshold value; and/or
the first device is a recipient of an SL-PRS transmitted by the second device, and a difference—defined as an RSRP associated with the third device minus an RSRP associated with the second device—is larger than a third threshold value; and/or
the first device is a recipient of an SL-PRS transmitted by the third device, and a difference—defined as an RSRP associated with second device minus an RSRP associated with the third device—is larger than a fourth threshold value.

In some embodiments, the first device may also determine whether to notify the second device or the third device to about the one or more SL-PRS resource reservation collisions involving the specified SL-PRS resources. Determining which device to notify may include basing the decision on:
a priority value of the second device and a priority value of the third device, when both the second device and the third device are capable of receiving IUC SL communications relating to SL-PRS; or
capability of the second device to receive IUC SL communications relating to SL-PRS and capability of the third device to receive IUC SL communications relating to SL-PRS.

The first device may transmit the indication according to signal prioritization defined by:
prioritization between transmission of IUC SL communication relating to SL-PRS, and transmission and/or reception of SL-HARQ; and/or
prioritization between transmission of IUC SL communication relating to SL-PRS, and transmission and/or reception of IUC SL communication relating to SL data; and/or
prioritization between transmission of IUC SL communication relating to SL-PRS, and reception of IUC SL communication relating to SL-PRS.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1-55. (canceled)

56. A method for wireless communications, the method comprising:
receiving, by a first device, first information identifying a resource pool for sidelink (SL) positioning communications;
receiving, by the first device, from a second device via a first inter-user-equipment-coordination (IUC) SL communication using one or more resources from the identified resource pool, an indication comprising second information about one or more sidelink positioning reference signal (SL-PRS) resources;
selecting, by the first device, at least one of the one or more SL-PRS resources based at least on the received second information; and
transmitting, by the first device, an SL-PRS using the selected at least one of the one or more SL-PRS resources.

57. The method of claim 56, wherein the resource pool comprises one or more of:
physical sidelink control channel (PSCCH) resources;
physical sidelink shared channel (PSSCH) resources;
physical sidelink feedback channel (PSFCH) resources; or
SL-PRS resources.

58. The method of claim 57, wherein when the resource pool comprises PSFCH resources and SL-PRS resources, the PSFCH resources and the SL-PRS resources are frequency division multiplexed.

59. The method of claim 57, wherein when the resource pool comprises PSFCH resources and SL-PRS resources, the PSFCH resources and the SL-PRS resources are time division multiplexed, sharing the last two symbols of a slot, wherein a first set of slots have PSFCH resources and a second set of slots different from the first set of slots have SL-PRS resources.

60. The method of claim 56, further comprising:
transmitting, by the first device to the second device, via a second IUC SL communication prior to receiving the indication, a request for SL-PRS resources, and
wherein receiving the indication comprises receiving the indication responsive to the request.

61. The method of claim 56,
wherein receiving the indication comprises receiving the indication in response to an IUC triggering condition, and
wherein the IUC triggering condition comprises one or more of:
a data size indicated by an SL buffer status report (SL-BSR) is larger than a configured resource pool threshold;
it is possible to include IUC SL communications with SL data transmissions performed by the second device; or
a predefined device-implementation-based condition.

62. The method of claim 56, further comprising:
transmitting, by the first device to the second device via a second IUC SL communication prior to receiving the indication, a request to have specified SL-PRS resources reserved for the first device; and
wherein receiving the indication comprises receiving the indication responsive to the request.

63. An apparatus comprising memory and a processor, the processor coupled to the memory and configured to:
receive first information identifying a resource pool for sidelink (SL) positioning communications;
receive an indication comprising second information about one or more sidelink positioning reference signal (SL-PRS) resources, wherein the indication is received from a second device via a first inter-user-equipment-coordination (IUC) SL communication using one or more resources from the identified resource pool;
select at least one of the one or more SL-PRS resources based at least on the received second information; and
generate an SL-PRS for transmission using the selected at least one of the one or more SL-PRS resources.

64. The apparatus of claim 63, wherein the resource pool comprises one or more of:
physical sidelink control channel (PSCCH) resources;
physical sidelink shared channel (PSSCH) resources;
physical sidelink feedback channel (PSFCH) resources; or
SL-PRS resources.

65. The apparatus of claim 64, wherein when the resource pool comprises PSFCH resources and SL-PRS resources, the PSFCH resources and the SL-PRS resources are frequency division multiplexed.

66. The apparatus of claim 64, wherein when the resource pool comprises PSFCH resources and SL-PRS resources, the PSFCH resources and the SL-PRS resources are time division multiplexed, sharing the last two symbols of a slot, wherein a first set of slots have PSFCH resources and a second set of slots different from the first set of slots have SL-PRS resources.

67. The apparatus of claim 63, wherein the apparatus is further configured to cause the UE to:
transmit, to the second device via a second IUC SL communication prior to receiving the indication, a request for SL-PRS resources, and
wherein receiving the indication comprises receiving the indication responsive to the request.

68. The apparatus of claim 63,
wherein receiving the indication comprises receiving the indication in response to an IUC triggering condition, and
wherein the IUC triggering condition comprises one or more of:
a data size indicated by an SL buffer status report (SL-BSR) is larger than a configured resource pool threshold;
it is possible to include IUC SL communications with SL data transmissions performed by the second device; or
a predefined device-implementation-based condition.

69. The apparatus of claim 63, wherein the apparatus is further configured to cause the UE to:
transmit, to the second device via a second IUC SL communication prior to receiving the indication, a request to have specified SL-PRS resources reserved for the UE, and
wherein receiving the indication comprises receiving the indication responsive to the request.

70. A user equipment (UE) comprising:
radio circuitry configured to enable wireless communications of the UE; and
an apparatus communicatively coupled to the radio circuitry and configured to cooperate with the radio circuitry to cause the UE to:
receive first information identifying a resource pool for sidelink (SL) positioning communications;
receive, from a second device via a first inter-user-equipment-coordination (IUC) SL communication using one or more resources from the identified resource pool, an indication comprising second information about one or more sidelink positioning reference signal (SL-PRS) resources;
select at least one of the one or more SL-PRS resources based at least on the received second information; and
transmit an SL-PRS using the selected at least one of the one or more SL-PRS resources.

71. The UE of claim 70, wherein the resource pool comprises one or more of:
physical sidelink control channel (PSCCH) resources;
physical sidelink shared channel (PSSCH) resources;
physical sidelink feedback channel (PSFCH) resources; or
SL-PRS resources.

72. The UE of claim 71, wherein when the resource pool comprises PSFCH resources and SL-PRS resources, the PSFCH resources and the SL-PRS resources are either:
frequency division multiplexed, or
time division multiplexed, sharing the last two symbols of a slot, wherein a first set of slots have PSFCH resources and a second set of slots different from the first set of slots have SL-PRS resources.

73. The UE of claim 70, wherein the apparatus is further configured to cause the UE to:
transmit, to the second device via a second IUC SL communication prior to receiving the indication, a request for SL-PRS resources, and
wherein receiving the indication comprises receiving the indication responsive to the request.

74. The UE of claim 70,
wherein receiving the indication comprises receiving the indication in response to an IUC triggering condition, and
wherein the IUC triggering condition comprises one or more of:
a data size indicated by an SL buffer status report (SL-BSR) is larger than a configured resource pool threshold;
it is possible to include IUC SL communications with SL data transmissions performed by the second device; or
a predefined device-implementation-based condition.

75. The UE of claim 70, wherein the apparatus is further configured to cause the UE to:
transmit, to the second device via a second IUC SL communication prior to receiving the indication, a request to have specified SL-PRS resources reserved for the UE, and
wherein receiving the indication comprises receiving the indication responsive to the request.
